(19) United States
(12) Patent Application Publication
(10) Pub. No.: US 2026/0245801 A1
(43) Pub. Date: Aug. 20, 2026

(54) MULTILAYER CERAMIC CAPACITOR

(71) Applicant: Murata Manufacturing Co., Ltd., Nagaokakyo-shi (JP)

(72) Inventors: Shoji FUKUI, Nagaokakyo-shi (JP); Kyosuke INOUE, Nagaokakyo-shi (JP); Akito MORI, Nagaokakyo-shi (JP)

(73) Assignee: Murata Manufacturing Co., Ltd., Nagaokakyo-shi (JP)

(21) Appl. No.: 19/641,648

(22) Filed: Apr. 8, 2026

Related U.S. Application Data
(63) Continuation of application No. PCT/JP2024/027644, filed on Aug. 2, 2024.

(30) Foreign Application Priority Data
Nov. 22, 2023 (JP) 2023-198283

(51) Int. Cl. H01G 4/252; H01G 4/30

(52) U.S. Cl. CPC H01G 4/252; H01G 4/30

(57) ABSTRACT

A multilayer ceramic capacitor includes an element body portion including dielectric layers and internal electrode layers that are layered in a layering direction, the element body portion including first and second main surfaces opposed to each other in the layering direction, first and second side surfaces opposed to each other in a width direction orthogonal to the layering direction, and first and second end surfaces opposed to each other in a length direction orthogonal to the layering and width directions, and an external electrode on each of the first and second end surfaces, the external electrode being electrically connected to the internal electrode layers, wherein the element body portion further includes side margin portions between the internal electrode layers and each of the first and second side surfaces in the width direction, the side margin portions including a coating layer that includes Si and K.

### CROSS-REFERENCE TO RELATED APPLICATIONS

This application is a continuation of PCT Application No. PCT/JP2024/027644, filed on Aug. 2, 2024, which claims priority to Japanese Patent Application No. 2023-198283, filed on Nov. 22, 2023. The entire contents of each of the above-listed applications are incorporated herein by reference.

### TECHNICAL FIELD

The present disclosure relates to a multilayer ceramic capacitor.

### BACKGROUND ART

Japanese Patent Laid-Open No. 2021-19010 (PTL 1) is a prior art document that discloses a configuration of a multilayer electronic component. The multilayer electronic component described in PTL 1 includes a ceramic element body and an external electrode. In the ceramic element body, a ceramic layer and an internal electrode layer are alternately layered. A side margin portion is formed by sintering a ceramic green sheet.

### CITATION LIST

### Patent Literature

### Ptl 1: Japanese Patent Laid-open No. 2021-19010

### SUMMARY

The present disclosure is directed to a multilayer ceramic capacitor, including an element body portion including a plurality of dielectric layers and a plurality of internal electrode layers that are layered in a layering direction, the element body portion including a first main surface and a second main surface opposed to each other in the layering direction, a first side surface and a second side surface opposed to each other in a width direction orthogonal to the layering direction, and a first end surface and a second end surface opposed to each other in a length direction orthogonal to the layering direction and the width direction, and an external electrode on each of the first end surface and the second end surface, the external electrode being electrically connected to the plurality of internal electrode layers, wherein the element body portion further includes side margin portions between the first side surface and the plurality of internal electrode layers and between the second side surface and the plurality of internal electrode layers in the width direction, the side margin portions include a coating layer that includes Si and K.

### BRIEF DESCRIPTION OF DRAWINGS

FIG. 1 is a perspective view schematically showing an appearance of a multilayer ceramic capacitor according to an embodiment.

FIG. 2 is a perspective view schematically showing an element body portion of the multilayer ceramic capacitor according to the embodiment.

FIG. 3 is a schematic cross-sectional view of the multilayer ceramic capacitor shown in FIG. 1 when viewed from a direction along the line III-III.

FIG. 4 is a schematic cross-sectional view of the multilayer ceramic capacitor shown in FIG. 1 when viewed from a direction along the line IV-IV.

FIG. 5 is a schematic cross-sectional view of the multilayer ceramic capacitor shown in FIG. 3 when viewed from a direction along the line V-V.

FIG. 6 is a schematic cross-sectional view of the multilayer ceramic capacitor shown in FIG. 3 when viewed from a direction along the line VI-VI.

FIG. 7 is a schematic cross-sectional view for illustrating details of a side margin portion of the multilayer ceramic capacitor according to the embodiment.

FIG. 8 is a schematic cross-sectional view for illustrating details of an outer layer portion of the multilayer ceramic capacitor according to the embodiment.

FIG. 9 is a schematic cross-sectional view for illustrating details of an end margin portion and an external electrode of the multilayer ceramic capacitor according to the embodiment.

FIG. 10 is a schematic cross-sectional view showing a detailed configuration of the external electrode of the multilayer ceramic capacitor according to the embodiment.

FIG. 11 is a schematic cross-sectional view for illustrating displacement in a width direction of a narrow-width portion of an internal electrode layer in the multilayer ceramic capacitor according to the embodiment.

FIG. 12 is a flowchart showing a method of manufacturing a multilayer ceramic capacitor according to the embodiment.

FIG. 13 is a schematic cross-sectional view for illustrating details of the end margin portion and the external electrode of a multilayer ceramic capacitor according to a modification.

FIG. 14 is a flowchart showing a method of manufacturing a multilayer ceramic capacitor according to the modification.

### DESCRIPTION OF EMBODIMENTS

An embodiment of the present disclosure will be described in detail below with reference to the drawings. In the embodiment shown below, the same or common elements have the same reference characters allotted in the drawings and description thereof will not be repeated. In the drawings, a length direction of an element body portion which will be described later is denoted as L, a width direction of the element body portion is denoted as W, and a layering direction of the element body portion is denoted as T.

A multilayer ceramic capacitor may include a ceramic green sheet that is sintered to form a side margin portion of the multilayer ceramic capacitor. The ceramic green sheet contains ceramic particles, and as the ceramic particles are sintered, they become the side margin portion. When moisture enters an interface between ceramic grains which result from the sintered ceramic particles, however, reliability may be reduced. Therefore, the side margin portion should be formed such that a plurality of ceramic grains are included in a direction of thickness of the side margin portion, thereby providing the side margin portion with a certain thickness or larger. Further, the side margin portion should have a certain thickness or larger, and there should be room for further reduction in size and increase in capacitance of a multilayer ceramic capacitor.

The present disclosure was made in view of above circumstances and is directed to providing a multilayer ceramic capacitor reduced in size and increased in capacitance, with moisture resistance being secured and with an area where an internal electrode layer can be arranged and made larger while a side margin portion is reduced in thickness.

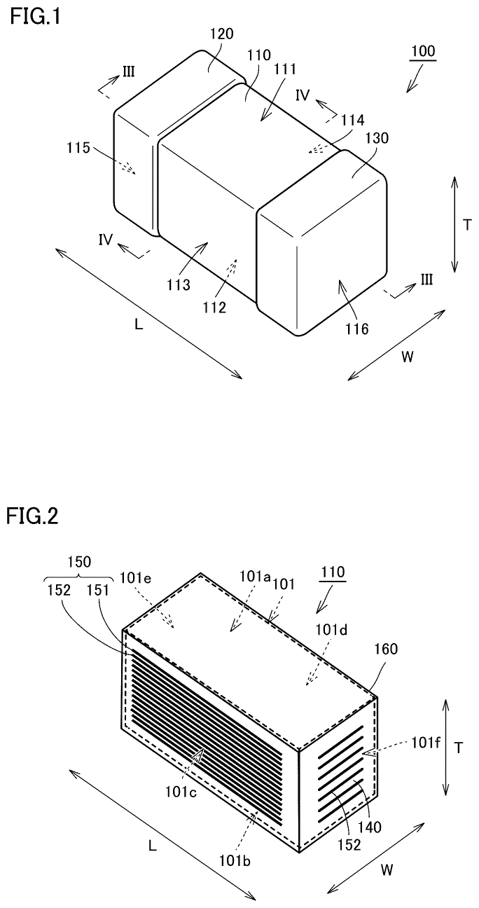

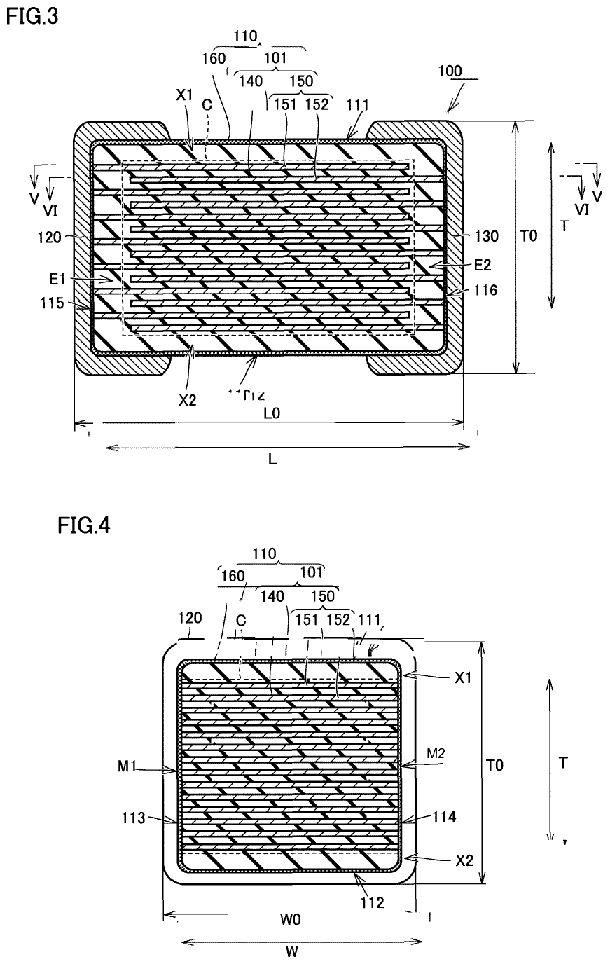

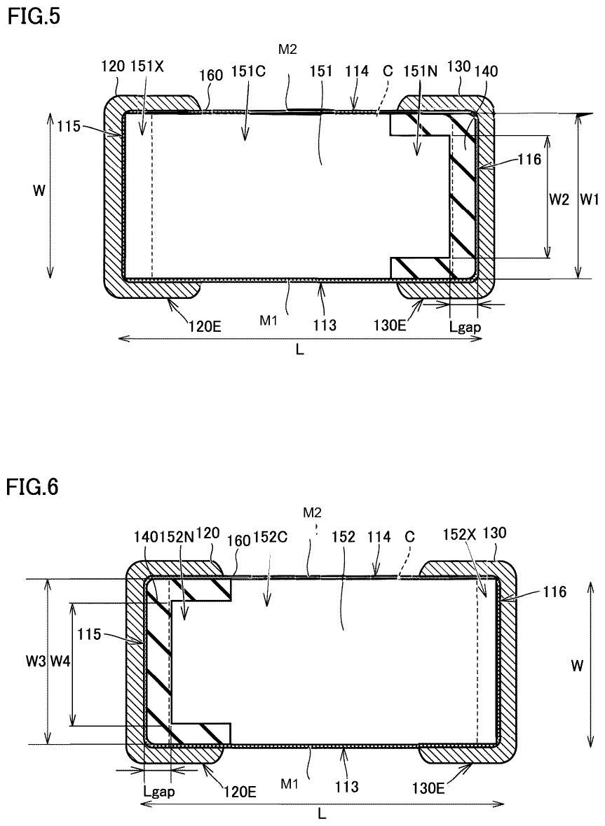

FIG. 1 is a perspective view schematically showing an appearance of a multilayer ceramic capacitor according to an embodiment. FIG. 2 is a perspective view schematically showing the element body portion of the multilayer ceramic capacitor according to the embodiment. FIG. 3 is a schematic cross-sectional view of the multilayer ceramic capacitor shown in FIG. 1 when viewed from a direction along the line III-III. FIG. 4 is a schematic cross-sectional view of the multilayer ceramic capacitor shown in FIG. 1 when viewed from a direction along the line IV-IV. FIG. 5 is a schematic cross-sectional view of the multilayer ceramic capacitor shown in FIG. 3 when viewed from a direction along the line V-V. FIG. 6 is a schematic cross-sectional view of the multilayer ceramic capacitor shown in FIG. 3 when viewed from a direction along the line VI-VI.

As shown in FIGS. 1 to 6, a multilayer ceramic capacitor 100 according to the embodiment includes an element body portion 110 and an external electrode. Multilayer ceramic capacitor 100 includes a first external electrode 120 and a second external electrode 130 as the external electrode.

As shown in FIG. 1, element body portion 110 is substantially in a shape of a parallelepiped. Element body portion 110 is provided with a first main surface 111 and a second main surface 112 opposed to each other in layering direction T, a first side surface 113 and a second side surface 114 opposed to each other in width direction W orthogonal to layering direction T, and a first end surface 115 and a second end surface 116 opposed to each other in length direction L orthogonal to layering direction T and width direction W.

Element body portion 110 may have a corner portion and a ridgeline portion rounded. The corner portion is a portion where three surfaces of element body portion 110 meet one another and the ridgeline portion is a portion where two surfaces of element body portion 110 meet each other.

As shown in FIGS. 1 and 3 to 6, first external electrode 120 is provided at first end surface 115. Specifically, first external electrode 120 is formed over the entire first end surface 115 and formed to extend from first end surface 115 to reach first main surface 111, second main surface 112, first side surface 113, and second side surface 114. As shown in FIGS. 5 and 6, first external electrode 120 includes an extension portion 120E that extends from first end surface 115 to (e.g., partially overlap or cover) each of first side surface 113 and second side surface 114.

As shown in FIGS. 1 and 3 to 6, second external electrode 130 is provided at second end surface 116. Specifically, second external electrode 130 is formed over the entire second end surface 116 and formed to extend from second end surface 116 to reach first main surface 111, second main surface 112, first side surface 113, and second side surface 114. As shown in FIGS. 5 and 6, second external electrode 130 includes an extension portion 130E that extends from second end surface 116 to (e.g., partially overlap or cover) each of first side surface 113 and second side surface 114.

A detailed configuration of first external electrode 120 and second external electrode 130 will be described later.

As shown in FIGS. 2 to 6, element body portion 110 includes a multilayer body 101 and a coating layer 160. Coating layer 160 contains Si and K.

Multilayer body 101 is provided with a pair of main surfaces 101a and 101b opposed to each other in layering direction T, a pair of side surfaces 101c and 101d opposed to each other in the width direction, and a pair of end surfaces 101e and 101f opposed to each other in the length direction. The pair of main surfaces 101a and 101b, the pair of side surfaces 101c and 101d, and the pair of end surfaces 101e and 101f are covered (e.g., continuously covered) with coating layer 160. Coating layer 160 is located at first side surface 113, second side surface 114, first main surface 111, and second main surface 112. A plurality of dielectric layers 140 are covered with coating layer 160 at first end surface 115 and second end surface 116. For example, an outer surface of the coating layer 160 that faces away from the multilayer body 101 may define the first side surface 113, second side surface 114, first main surface 111, second main surface 112, first end surface 115, and second end surface 116.

As shown in FIGS. 2 to 4, multilayer body 101 includes a plurality of dielectric layers 140 and a plurality of internal electrode layers 150 that are alternately layered along layering direction T.

The plurality of internal electrode layers 150 include a plurality of first internal electrode layers 151 and a plurality of second internal electrode layers 152. The plurality of first internal electrode layers 151 and the plurality of second internal electrode layers 152 are alternately layered in layering direction T.

The plurality of first internal electrode layers 151 are drawn to end surface 101e (e.g., to extend beyond terminal edges of the second internal electrode layers 152). The plurality of first internal electrode layers 151 are electrically connected to first external electrode 120. The plurality of second internal electrode layers 152 are drawn to end surface 101f (e.g., to extend beyond terminal edges of the first internal electrode layers 151). The plurality of second internal electrode layers 152 are electrically connected to second external electrode 130. Opposing ends in width direction W of the plurality of first internal electrode layers 151 and the plurality of second internal electrode layers 152 are exposed at side surfaces 101c and 101d.

Though FIGS. 2 to 4 show an example where seven first internal electrode layers 151 and seven second internal electrode layers 152 are provided, the number of first internal electrode layers 151 and the number of second internal electrode layers 152 are each not limited to seven. The total number of internal electrode layers 150 may not be smaller than one and not larger than one thousand. Internal electrode layer 150 (e.g., each internal electrode layer 150) may have a thickness not smaller than 0.3 μm and not larger than 0.8 μm in layering direction T.

As shown in FIG. 5, first internal electrode layer 151 includes a first opposed portion 151C and a first drawn portion 151X. First opposed portion 151C is opposed to second internal electrode layer 152 adjacent in layering direction T. First drawn portion 151X connects first opposed portion 151C and first external electrode 120 to each other. First drawn portion 151X is drawn toward first end surface 115. First opposed portion 151C and first drawn portion 151X are integrally formed.

First internal electrode layer 151 is provided with a first narrow-width portion 151N narrower in width in width direction W than a central portion in length direction L, on a side opposite to a side where it is connected to first external electrode 120 in length direction L. In width direction W, a width W2 of first narrow-width portion 151N is narrower than a width W1 of first opposed portion 151C.

As shown in FIG. 5, a region where adjacent internal electrode layers 150 in element body portion 110 on a side of second end surface 116 are not superimposed on each other in layering direction T, that is, a region from an end on the side of second end surface 116 of a region where internal electrode layers 150 adjacent to each other are superposed on each other in layering direction T to second end surface 116, is defined as Lgap.

First narrow-width portion 151N does not necessarily have to be formed, and a portion where first narrow-width portion 151N is formed may have width W1. For example, in this case, a length in length direction L of extension portion 120E of first external electrode 120 (or length of extension portion 130E of second external electrode 130) is shorter than a length of Lgap along length direction L or extension portion 120E (or extension portion 130E) is not formed.

As shown in FIG. 6, second internal electrode layer 152 includes a second opposed portion 152C and a second drawn portion 152X. Second opposed portion 152C is opposed to first internal electrode layer 151 adjacent in layering direction T. Second drawn portion 152X connects second opposed portion 152C and second external electrode 130 to each other. Second drawn portion 152X is drawn toward second end surface 116. Second opposed portion 152C and second drawn portion 152X are integrally formed.

Second internal electrode layer 152 is provided with a second narrow-width portion 152N narrower in width in width direction W than a central portion in length direction L, on a side opposite to a side where it is connected to second external electrode 130 in length direction L. In width direction W, a width W4 of second narrow-width portion 152N is narrower than a width W3 of second opposed portion 152C.

As shown in FIG. 6, a region where adjacent internal electrode layers 150 in element body portion 110 on a side of first end surface 115 are not superimposed on each other in layering direction T, that is, a region from an end on the side of first end surface 115 of the region where internal electrode layers 150 adjacent to each other are superimposed on each other in layering direction T to first end surface 115, is defined as Lgap.

Second narrow-width portion 152N does not necessarily have to be formed, and a portion where second narrow-width portion 152N is formed may have width W3. For example, in this case, a length in length direction L of extension portion 130E of second external electrode 130 is shorter than a length of Lgap along length direction L or extension portion 130E is not formed.

Each of first internal electrode layer 151 and second internal electrode layer 152 includes at least one metal selected from Ni, Cu, Ag, Pd, and Au or an alloy including the metal. For example, in the present embodiment, each of first internal electrode layer 151 and second internal electrode layer 152 includes Ni as a main component. Each of first internal electrode layer 151 and second internal electrode layer 152 may further include dielectric particles based on the same composition as ceramic contained in dielectric layer 140. Each of first internal electrode layer 151 and second internal electrode layer 152 may include Sn at an interface with dielectric layer 140.

The plurality of dielectric layers 140 are formed from an outer dielectric layer located between internal electrode layer 150 located closest to first main surface 111 in layering direction T and first main surface 111 and an outer dielectric layer located between internal electrode layer 150 located closest to second main surface 112 in layering direction T and second main surface 112 as well as an inner dielectric layer located between internal electrode layers 150 adjacent in layering direction T. The number of dielectric layers 140 may not be smaller than one hundred and not larger than one thousand. Dielectric layer 140 may have a thickness not smaller than 0.4 μm and not larger than 0.8 μm.

Dielectric ceramic including, for example, such a component as BaTiO₃, CaTiO₃, SrTiO₃, or CaZrO₃ can be employed as a ceramic material for the plurality of dielectric layers 140. A material obtained by addition of a sub component such as an Mn compound, an Fe compound, a Cr compound, a Co compound, or an Ni compound to these main components may be employed.

As shown in FIGS. 3 and 4, element body portion 110 is partitioned into an inner layer portion C, a first outer layer portion X1 and a second outer layer portion X2, a first side margin portion M1 and a second side margin portion M2, and a first end margin portion E1 and a second end margin portion E2. Inner layer portion C has a capacitance by layering of later-described first opposed portion 151C of first internal electrode layer 151 and later-described second opposed portion 152C of second internal electrode layer 152 in layering direction T.

First outer layer portion X1 and second outer layer portion X2 sandwich inner layer portion C therebetween in layering direction T. First outer layer portion X1 is located outside inner layer portion C in layering direction T and located on a side of first main surface 111. In other words, first outer layer portion X1 is located closer to first main surface 111 relative to internal electrode layer 150 located closest to first main surface 111 in layering direction T. Second outer layer portion X2 is located outside inner layer portion C in layering direction T and located on a side of second main surface 112. In other words, second outer layer portion X2 is located closer to second main surface 112 relative to internal electrode layer 150 located closest to second main surface 112 in layering direction T.

Each of first outer layer portion X1 and second outer layer portion X2 extends in length direction L and width direction W so as to include the ridgeline portion of element body portion 110. Each of first outer layer portion X1 and second outer layer portion X2 may have a thickness not smaller than 10 μm and not larger than 30 μm.

Each of first outer layer portion X1 and second outer layer portion X2 includes an outermost layer portion arranged outermost and an inner-side outer layer portion located inside this outermost layer portion. The outermost layer portion is formed from coating layer 160. The inner-side outer layer portion is formed from the outer dielectric layer.

As shown in FIG. 3, first end margin portion E1 and second end margin portion E2 sandwich inner layer portion C therebetween in length direction L. First end margin portion E1 is located outside inner layer portion C in length direction L and located on the side of first end surface 115. Second end margin portion E2 is located outside inner layer portion C in length direction L and located on the side of second end surface 116.

As shown in FIGS. 4 to 6, in element body portion 110, the side margin portion is located between first side surface 113 and the plurality of internal electrode layers 150 and between second side surface 114 and the plurality of internal electrode layers 150 in width direction W. The side margin portion is formed from coating layer 160. Coating layer 160 covers opposing ends of the plurality of internal electrode layers 150 in width direction W.

Specifically, first side margin portion M1 is provided at side surface 101c of the multilayer body. First side margin portion M1 is provided to cover the entire side surface 101c. First side margin portion M1 is present from one end of internal electrode layer 150 located on one side in width direction W to first side surface 113 in element body portion 110. In other words, coating layer 160 is formed at one end in width direction W and at the central portion in length direction L of each of the plurality of internal electrode layers 150.

Second side margin portion M2 is provided at side surface 101d of the multilayer body. Second side margin portion M2 is provided to cover the entire side surface 101d. Second side margin portion M2 is present from the other end of internal electrode layer 150 located on the other side in width direction W to second side surface 114 in element body portion 110. In other words, coating layer 160 is formed at the other end in width direction W and at the central portion in length direction L of each of the plurality of internal electrode layers 150.

A size of multilayer ceramic capacitor 100 including element body portion 110, first external electrode 120, and second external electrode 130 is not particularly limited, and for example, a range below may be adopted.

As shown in FIG. 3, a dimension in length direction L (a length dimension L0) of multilayer ceramic capacitor 100 is, for example, not smaller than 0.1 mm and not larger than 3.2 mm. A dimension in layering direction T (a thickness dimension T0) of multilayer ceramic capacitor 100 is not smaller than 0.05 mm and not larger than 1.6 mm. As shown in FIG. 4, a dimension in width direction W (a width dimension W0) of multilayer ceramic capacitor 100 is, for example, not smaller than 0.05 mm and not larger than 1.6 mm.

Multilayer ceramic capacitor 100 has, for example, a size of length dimension L0 of 0.1 mm, width dimension W0 of 0.05 mm, and thickness dimension T0 of 0.05 mm, a size of length dimension L0 of 0.6 mm, width dimension W0 of 0.3 mm, and thickness dimension T0 of 0.3 mm, a size of length dimension L0 of 1.0 mm, width dimension W0 of 0.5 mm, and thickness dimension T0 of 0.5 mm, a size of length dimension L0 of 1.6 mm, width dimension W0 of 0.8 mm, and thickness dimension T0 of 0.8 mm, or a size of length dimension L0 of 3.2 mm, width dimension W0 of 1.6 mm, and thickness dimension T0 of 1.6 mm. A tolerance is added to the size above.

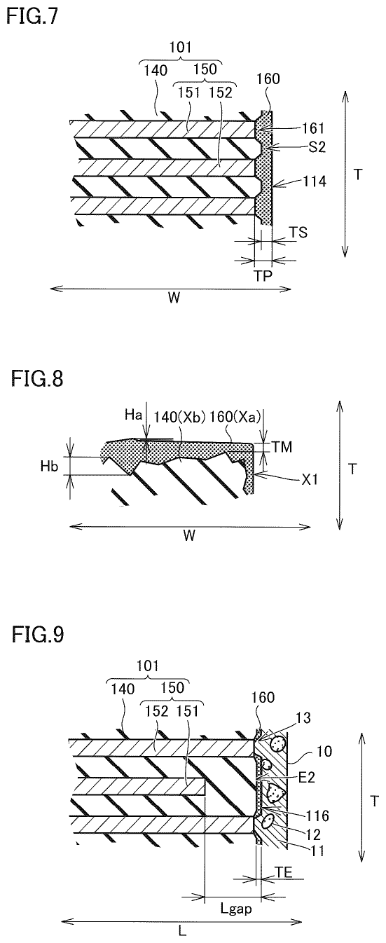

FIG. 7 is a schematic cross-sectional view for illustrating details of the side margin portion of the multilayer ceramic capacitor according to the embodiment. FIG. 7 shows a cross-section of element body portion 110 in parallel to layering direction T and width direction W, on a side of second side surface 114. Though a side of second side margin portion M2 will be described in the description below, a side of first side margin portion M1 is also similar.

As shown in FIG. 7, second side margin portion M2 is formed from coating layer 160 containing Si and K. A composition of coating layer 160 can be confirmed by energy dispersive X-ray spectroscopy (EDX). Coating layer 160 is amorphous, and amorphism of coating layer 160 can be confirmed by Raman spectroscopy. Amorphism of coating layer 160 can be confirmed also based on the fact that a specific crystal pattern cannot be detected in X-ray diffraction of coating layer 160.

Second side margin portion M2 projects as being in contact (e.g., direct contact) with the ends in width direction W of the plurality of internal electrode layers 150. A part 161 of coating layer 160 in a portion that covers opposing ends of the plurality of internal electrode layers 150 in width direction W thus lies between dielectric layers 140 adjacent in layering direction T among the plurality of dielectric layers 140 (e.g., the part 161 of coating layer 160 may include a plurality of portions extending or projecting from a linear portion of the coating layer 160 to directly contact and cover respective ends of the plurality of internal electrode layers 150 in width direction W, while being separated from each other by the dielectric layers 140). The reason for such a shape is that internal electrode layer 150 is higher in ratio of shrinkage than dielectric layer 140 in firing. With this shape of the side margin portion, strength of fixing of the side margin portion to side surfaces 101c and 101d of multilayer body 101 can be increased. Then, separation of the side margin portion can be suppressed.

A minimum thickness TS of coating layer 160 located on the ends of the plurality of internal electrode layers 150 in width direction W (e.g., a minimum width in regions between portions of part 161) is not smaller than 0.01 μm and not larger than 10 μm. From a point of view of moisture resistance, minimum thickness TS may not be smaller than 0.1 μm and furthermore not smaller than 0.3 μm. A shortest distance TP between the plurality of internal electrode layers 150 and first side surface 113 and shortest distance TP between the plurality of internal electrode layers 150 and second side surface 114 (e.g., a width at regions including the portions of part 161) may not be shorter than 0.01 μm and not longer than 10 μm. From a point of view of moisture resistance, shortest distance TP is not shorter than 0.1 μm and furthermore not shorter than 0.3 μm. Numerical ranges of minimum thickness TS and shortest distance TP are not limited to above.

Relation of the shape and the thickness described with reference to FIG. 7 can be confirmed by polishing element body portion 110 from a side of first external electrode 120 to the central portion in length direction L and observing the cross-section of element body portion 110 in parallel to layering direction T and width direction W with an electron microscope or the like. A smallest thickness of coating layer 160 measured in an image picked up by a scanning electron microscope (SEM), of a range where approximately ten first internal electrode layers 151 or approximately ten second internal electrode layers 152 are included in a field of view at the central portion of the cross-section in layering direction T, is defined as minimum thickness TS. Similarly, a shortest distance measured between internal electrode layers 150 and first side surface 113 or second side surface 114 in the image is defined as shortest distance TP.

FIG. 8 is a schematic cross-sectional view for illustrating details of the outer layer portion of the multilayer ceramic capacitor according to the embodiment. FIG. 8 shows the cross-section of element body portion 110 in parallel to layering direction T and width direction W on a side of first outer layer portion X1. Though the side of first outer layer portion X1 will be described in the description below, a side of second outer layer portion X2 is also similar.

As shown in FIG. 8, first outer layer portion X1 includes an outermost layer portion Xa arranged outermost and an inner-side outer layer portion Xb located inside outermost layer portion Xa. Outermost layer portion Xa is formed from coating layer 160. Inner-side outer layer portion Xb is formed from outer dielectric layer 140.

At an outer surface of inner-side outer layer portion Xb, there are fine projections and recesses resulting from dielectric grains in outer dielectric layer 140. Coating layer 160 is amorphous and it covers inner-side outer layer portion Xb to bury projections and recesses at the outer surface of inner-side outer layer portion Xb. Accordingly, there are few projections and recesses at an outer surface of outermost layer portion Xa. Therefore, a maximum height Ha of projections and recesses at the outer surface of outermost layer portion Xa is lower than a maximum height Hb of projections and recesses at the outer surface of inner-side outer layer portion Xb. Impact resistance of outermost layer portion Xa can thus be enhanced and lowering in moisture resistance of multilayer ceramic capacitor 100 can be suppressed.

A minimum thickness TM of coating layer 160 in layering direction T in each of first outer layer portion X1 and second outer layer portion X2 is not smaller than 0.01 μm and not larger than 0.5 μm. A numerical range of minimum thickness TM is not limited to above.

Relation of the shape and the thickness described with reference to FIG. 8 can be confirmed by polishing element body portion 110 from the side of first external electrode 120 to the central portion in length direction L and observing the cross-section of element body portion 110 in parallel to layering direction T and width direction W with an electron microscope or the like. A smallest thickness in layering direction T of coating layer 160 measured in an image picked up by a scanning electron microscope (SEM), of a range where first outer layer portion X1 or second outer layer portion X2 is included in a field of view at an end of the cross-section in layering direction T, is defined as minimum thickness TM.

FIG. 9 is a schematic cross-sectional view for illustrating details of the end margin portion and the external electrode of the multilayer ceramic capacitor according to the embodiment. FIG. 9 shows a cross-section of element body portion 110 in parallel to layering direction T and length direction L on a side of second end margin portion E2. Though the side of second end margin portion E2 will be described in the description below, a side of first end margin portion E1 is also similar.

As shown in FIG. 9, the external electrode (e.g., the external electrode 130 in FIGS. 1 and 3) includes a Cu layer 10 containing a glass component 12 while it contains a Cu component 11 as a main component. A composition of Cu layer 10 can be confirmed by EDX. Coating layer 160 is arranged at second end surface 116 (e.g., the coating layer 160 may be arranged between the Cu layer 10 and edges of second internal electrode layers 152), and a part 13 of Cu layer 10 passes through coating layer 160 and is electrically connected to second internal electrode layers 152. Coating layer 160 is located between the plurality of dielectric layers 140 and the external electrode. Specifically, coating layer 160 is located between edges of the plurality of dielectric layers 140 and the Cu layer 10. Cu layer 10 has a thickness not smaller than 30 μm and not larger than 100 μm at the central portion in layering direction T and width direction W. A numerical range of the thickness of Cu layer 10 is not limited to above. Cu layer 10 may be a resin layer containing the Cu component and the glass component. In this case, an underlying metallic layer is formed between the resin layer and coating layer 160.

Minimum thickness TS of coating layer 160 located on the ends of the plurality of internal electrode layers 150 in width direction W shown in FIG. 7 is larger than a minimum thickness TE of coating layer 160 located between the plurality of dielectric layers 140 and Cu layer 10 which is the external electrode shown in FIG. 9.

Relation of the shape and the thickness described with reference to FIG. 9 can be confirmed by polishing element body portion 110 from a side of first side surface 113 to the central portion in width direction W and observing the cross-section of element body portion 110 in parallel to layering direction T and length direction L with an electron microscope or the like. A smallest thickness of coating layer 160 measured in an image picked up by an SEM, of a range where approximately ten first internal electrode layers 151 or approximately ten second internal electrode layers 152 are included in the field of view at the central portion of the cross-section in layering direction T and at the end of the cross-section in length direction L, is defined as minimum thickness TE.

The reason for the shape as shown in FIG. 9 is as below. Coating layer 160 contains K, which makes a melting point of Si contained in coating layer 160 lower than a temperature for firing Cu layer 10. Therefore, coating layer 160 is molten at the time of firing of Cu layer 10, shrinkage force of Cu layer 10 is applied to molten coating layer 160, and part 13 of Cu layer 10 passes through coating layer 160 (e.g., passes through an opening in the molten coating layer 160) and is connected to second internal electrode layers 152.

In glass component 12 in Cu layer 10, K contained in coating layer 160 is diffused as being fluidized. In other words, K is contained in glass component 12. A concentration of K contained in glass component 12 is higher as a distance from second end surface 116 is shorter. In addition, some of Si contained in coating layer 160 has been introduced in Cu layer 10 as binding to glass component 12 in Cu layer 10. Cu is diffused from Cu layer 10 into Ni in internal electrode layer 150. Strength of fixing between Cu layer 10 and internal electrode layer 150 thus increases. Then, separation of first external electrode 120 and second external electrode 130 can be suppressed.

A concentration of Si in coating layer 160 located on the ends of the plurality of internal electrode layers 150 in width direction W shown in FIG. 7 is higher than a concentration of Si in coating layer 160 located between the plurality of dielectric layers 140 and the external electrode shown in FIG. 9.

A concentration of K in coating layer 160 located on the ends of the plurality of internal electrode layers 150 in width direction W shown in FIG. 7 is higher than a concentration of K in coating layer 160 located between the plurality of dielectric layers 140 and the external electrode shown in FIG. 9.

A concentration distribution of Si and K may be observed in an image picked up by a transmission electron microscope (TEM) or EDX. For example, a concentration gradient of Si and K is measured with the TEM as a molar ratio to 100 mol of Ti contained in dielectric layer 140 in an image picked up by the TEM, of a range where approximately one first internal electrode layer 151 or approximately one second internal electrode layer 152 is included in the field of view.

According to the configuration of coating layer 160 and the external electrode above, while moisture resistance is secured by the side margin portion small in thickness, electrical connection between internal electrode layers 150 and the external electrode can be secured without removal of coating layer 160 at first end surface 115 and second end surface 116 by sandblasting or the like. Then, a region where internal electrode layers 150 can be arranged can be made larger to achieve reduction in size and a larger capacitance of multilayer ceramic capacitor 100. In other words, the amorphous nature of the coating layer 160 may allow for a localized melting during the firing of the external electrode, and may allow the external electrode to form a direct electrical connection to the internal electrode layers 150 through the localized melted coating layer 160 without a prior removal step of the coating layer 160.

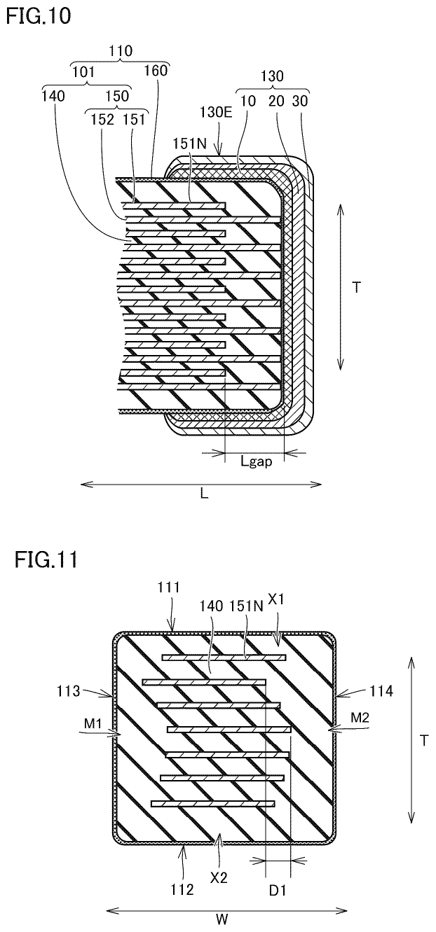

FIG. 10 is a schematic cross-sectional view showing a detailed configuration of the external electrode of the multilayer ceramic capacitor according to the embodiment. FIG. 10 shows the cross-section of element body portion 110 in parallel to layering direction T and length direction L on a side of second external electrode 130. Though the side of second external electrode 130 will be described in the description below, the side of first external electrode 120 is also similar.

As shown in FIG. 10, first external electrode 120 and second external electrode 130 each include Cu layer 10 provided on element body portion 110, an Ni plated layer 20 provided on Cu layer 10, and an Sn plated layer 30 provided on Ni plated layer 20.

A material for the plated layer may be a type of metal selected from Ni, Cu, Ag, Pd, and Au or an alloy containing the metal. A total thickness of Ni plated layer 20 and Sn plated layer 30 is, for example, not smaller than 3 μm and not larger than 20 μm.

In the present embodiment, as shown in FIG. 6, extension portion 120E is overlaid only at narrow-width portion 152N, on second internal electrode layer 152 not electrically connected to first external electrode 120 including extension portion 120E, among the plurality of internal electrode layers 150 when viewed in width direction W. As shown in FIGS. 5 and 10, extension portion 130E is overlaid only at narrow-width portion 151N, on first internal electrode layer 151 not electrically connected to second external electrode 130 including extension portion 130E, among the plurality of internal electrode layers 150 when viewed in width direction W.

Electrical connection between extension portion 120E and the end in width direction W of second internal electrode layer 152 and resultant short-circuiting therebetween can thus be suppressed. Similarly, electrical connection between extension portion 130E and the end in width direction W of first internal electrode layer 151 and resultant short-circuiting therebetween can be suppressed.

FIG. 11 is a schematic cross-sectional view for illustrating displacement in the width direction of the narrow-width portion of the internal electrode layer in the multilayer ceramic capacitor according to the embodiment. A position of the narrow-width portion is not limited to a manner shown in FIG. 11, because it is illustrated in FIG. 11 for the sake of convenience for description of an amount of displacement of the narrow-width portion.

As shown in FIG. 11, an amount of displacement D1 in width direction W between the first narrow-width portion 151N located closest to first side surface 113 among the plurality of first narrow-width portions 151N and first narrow-width portion 151N located closest to second side surface 114 among the plurality of first narrow-width portions 151N is not smaller than 3 μm.

As shown in FIG. 4, on the other hand, in the cross-section of element body portion 110 in parallel to layering direction T and width direction W at the central portion of element body portion 110 in length direction L, an amount of displacement in width direction W of internal electrode layers 150 adjacent in layering direction T is smaller than 3 μm.

In other words, an amount of position displacement in width direction W of first narrow-width portion 151N and second narrow-width portion 152N is larger than an amount of position displacement in width direction W at the central portion in length direction L of the plurality of internal electrode layers 150.

Therefore, a width of each of first narrow-width portion 151N and second narrow-width portion 152N may be narrower than a width at the central portion in length direction L of the plurality of internal electrode layers 150, by a maximum amount of position displacement assumed in width direction W of first narrow-width portion 151N and second narrow-width portion 152N. Electrical connection between extension portion 120E and the end in width direction W of second internal electrode layer 152 and resultant short-circuiting therebetween can thus be suppressed in a stable manner. Similarly, electrical connection between extension portion 130E and the end in width direction W of first internal electrode layer 151 and resultant short-circuiting therebetween can be suppressed in a stable manner.

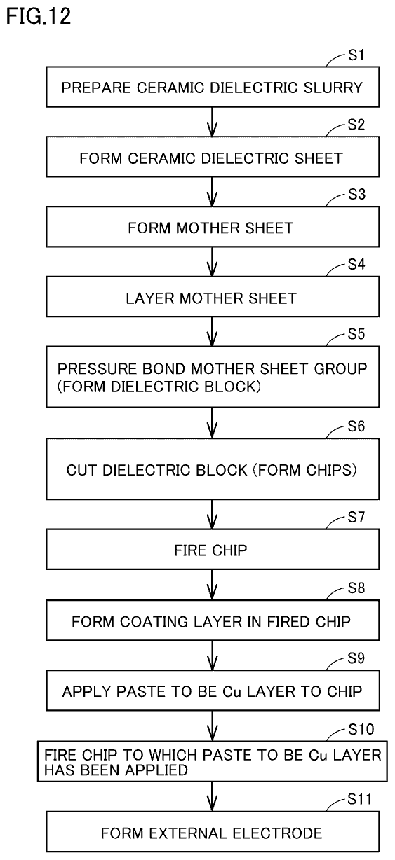

A method of manufacturing multilayer ceramic capacitor 100 according to the present embodiment will be described below. FIG. 12 is a flowchart showing the method of manufacturing the multilayer ceramic capacitor according to the embodiment.

As shown in FIG. 12, ceramic dielectric slurry is prepared (step S1). Specifically, ceramic dielectric powders, additive powders, binder resin, a solvent, and the like are mixed as being dispersed to prepare ceramic dielectric slurry. Ceramic dielectric powders are, for example, dielectric particles having a perovskite structure of BaTiO₃, CaTiO₃, SrTiO₃, CaZrO₃, CaHfO₃, or the like. Additive powders are composed, for example, of at least one of an Si compound, an Mg compound, an Mn compound, an Fe compound, a Cr compound, an Ni compound, and a Co compound. Polyurethane resin, urea resin, melamine resin, epoxy resin, vinyl acetate resin, acrylic resin, an aqueous high polymer such as polyvinyl alcohol (PVA) or polyvinyl butyral (PVB), or the like can be adopted as the binder resin. One of them may be used alone or at least two of them may be used as being mixed. Ceramic dielectric slurry may be based on a solvent or water. In an example where ceramic dielectric slurry is a water-based paint, ceramic dielectric slurry is prepared by mixing a water-soluble binder, a dispersant, and the like with a dielectric source material dissolved in water.

A ceramic dielectric sheet is then formed (step S2). Specifically, the ceramic dielectric sheet is formed by forming the ceramic dielectric slurry (from step S1) into a sheet on a carrier film with the use of a die coater, a gravure coater, a microgravure coater, or the like and drying the same. From a point of view of reduction in size and a higher capacitance of the multilayer ceramic capacitor, the ceramic dielectric sheet may have a thickness not smaller than 0.4 μm and not larger than 0.8 μm.

A mother sheet is then formed (step S3). Specifically, a conductive paste is applied to the ceramic dielectric sheet (from step S2) in a prescribed pattern so as to form the mother sheet in which a prescribed internal electrode pattern has been provided on the ceramic dielectric sheet. The conductive paste contains Ni powders, a solvent, a dispersant, a binder, and the like, and it is prepared to be constant in viscosity. Polyvinyl butyral (PVB), polyvinyl alcohol (PVA), or the like is employed as the binder. A screen printing method, an ink jet method, a gravure printing method, or the like can be employed as the method of applying the conductive paste. From a point of view of reduction in size and a higher capacitance of the multilayer ceramic capacitor, the internal electrode pattern may have a thickness not smaller than 0.3 μm and not larger than 0.8 μm. A ceramic dielectric sheet not subjected to step S3 is also prepared as the mother sheet (i.e., without the internal electrode pattern), in addition to the mother sheet provided with the internal electrode pattern.

A plurality of mother sheets are then layered (step S4). Specifically, a plurality of mother sheets not provided with the internal electrode pattern and formed only from ceramic dielectric sheets are layered, for example, to a thickness not smaller than 10 μm and not larger than 30 μm. On those mother sheets, a prescribed number of mother sheets provided with the internal electrode pattern are layered. The number of layered mother sheets provided with the internal electrode pattern is, for example, not smaller than one and not larger than one thousand. Further on those mother sheets, a prescribed number of mother sheets not provided with the internal electrode pattern and formed only from ceramic dielectric sheets are layered, for example, to a thickness not smaller than 10 μm and not larger than 30 μm. A mother sheet group is thus formed.

A dielectric block is then formed by pressure bonding of the mother sheet group (step S5). Specifically, the mother sheet group is pressurized and pressure bonded in the layering direction by isostatic pressing or rigid pressing to form the dielectric block. At this time, ceramic dielectric sheets are brought in intimate contact with each other by being pressed at a prescribed temperature. A dielectric sheet provided with the internal electrode pattern can be protected by arrangement of ceramic dielectric sheets corresponding to a certain thickness as the outermost layer in the layering direction and pressing of the same.

The dielectric block is then divided to form chips (step S6). Specifically, the dielectric block is divided in matrix by press cutting, dicing, or laser cutting and singulated to a plurality of chips. In division of the dielectric block, the dielectric block may be divided while it is heated to soften.

The chips are then fired (step S7). Specifically, the chips are heated so that a dielectric material and a conductive material contained in the chips are fired and multilayer body 101 is formed. A temperature for firing is set as appropriate in accordance with the dielectric material and the conductive material.

Coating layer 160 is then formed in the fired chips (step S8). Specifically, fired multilayer body 101 is immersed in a solution containing Si and K and thereafter dried. The solution is, for example, water glass containing K.

A paste to be Cu layer 10 is then applied to the chips (step S9). Specifically, the paste containing the glass component while it contains Cu particles is applied to each of first end surface 115 and second end surface 116 of dried element body portion 110 and dried (i.e., the paste is applied to the dried coating layer 160 on the element body portion 110).

The chips to which the paste to be Cu layer 10 has been applied are then fired (step S10). Specifically, element body portion 110 to which the paste to be Cu layer 10 has been applied is fired at a temperature not lower than 600° C. and not higher than 800° C. A metallic component contained in the paste to be Cu layer 10 is thus sintered and coating layer 160 is molten, so that first internal electrode layer 151 and Cu layer 10 are electrically connected to each other at first end surface 115 and second internal electrode layer 152 and Cu layer 10 are electrically connected to each other at second end surface 116. In other words, during the firing, firing of the paste, melting of the coating layer 160, and the electrical connection are performed simultaneously, so a separate step of removing portions of the coating layer 160 to provide electrical connection is not required.

The external electrode is then formed (step S11). Ni plating and Sn plating are applied to Cu layer 10 in this order to form Ni plated layer 20 and Sn plated layer 30, and thus first external electrode 120 and second external electrode 130 are formed.

Through a series of steps described above, multilayer ceramic capacitor 100 according to the embodiment can be manufactured.

A multilayer ceramic capacitor according to a modification of the present embodiment will be described below. The multilayer ceramic capacitor according to the modification is different from multilayer ceramic capacitor 100 according to the present embodiment mainly in that an underlying electrode layer containing Ni as a main component is formed on first end surface 115 and second end surface 116 of element body portion 110, and description of features similar to those in multilayer ceramic capacitor 100 according to the present embodiment will not be repeated.

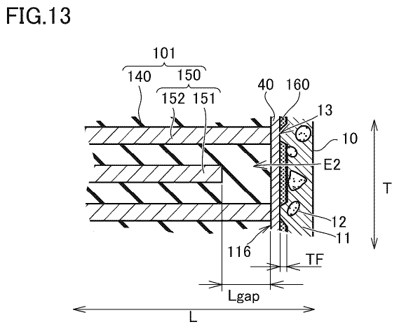

FIG. 13 is a schematic cross-sectional view for illustrating details of the end margin portion and the external electrode of the multilayer ceramic capacitor according to the modification. FIG. 13 shows the cross-section of element body portion 110 in parallel to layering direction T and length direction L on the side of second end margin portion E2. Though the side of second end margin portion E2 will be described in the description below, the side of first end margin portion E1 is also similar.

As shown in FIG. 13, the external electrode includes an underlying electrode layer 40 containing Ni as the main component and Cu layer 10 containing glass component 12 while it contains Cu component 11 as the main component. Underlying electrode layer 40 may further contain dielectric particles based on the same composition as ceramic contained in dielectric layer 140.

Underlying electrode layer 40 is formed on second end surface 116, coating layer 160 is formed on underlying electrode layer 40, and Cu layer 10 is formed on coating layer 160 (e.g., the coating layer 160 is formed between the underlying electrode layer 40 and the Cu layer 10). Underlying electrode layer 40 is covered with Cu layer 10.

Minimum thickness TS of coating layer 160 located on the ends of the plurality of internal electrode layers 150 in width direction W shown in FIG. 7 is larger than a minimum thickness TF of coating layer 160 located between underlying electrode layer 40 and Cu layer 10 shown in FIG. 13.

As shown in FIG. 13, part 13 of Cu layer 10 passes through coating layer 160 and is electrically connected to underlying electrode layer 40. Cu layer 10 is electrically connected to second internal electrode layers 152 through underlying electrode layer 40.

In the present modification, underlying electrode layer 40 is formed to extend from second end surface 116 to reach first main surface 111, second main surface 112, first side surface 113, and second side surface 114. Similarly, underlying electrode layer 40 is formed to extend from first end surface 115 to reach first main surface 111, second main surface 112, first side surface 113, and second side surface 114.

In the multilayer ceramic capacitor according to the modification, Cu layer 10 and second internal electrode layers 152 are electrically connected to each other through underlying electrode layer 40 that covers the entire second end surface 116, and hence second internal electrode layers 152 and second external electrode 130 can electrically be connected to each other in a stable manner. Similarly, Cu layer 10 and first internal electrode layers 151 are electrically connected to each other through underlying electrode layer 40 that covers the entire first end surface 115, and hence first internal electrode layers 151 and first external electrode 120 can electrically be connected to each other in a stable manner.

### In Glass Component 12 in Cu Layer 10, K Contained in Coating Layer 160 Is

diffused as being fluidized. Some of Si contained in coating layer 160 has been introduced in Cu layer 10 as binding to glass component 12 in Cu layer 10. Cu is diffused from Cu layer 10 into Ni in underlying electrode layer 40. Strength of fixing between Cu layer 10 and underlying electrode layer 40 thus increases. Then, separation of first external electrode 120 and second external electrode 130 can be suppressed.

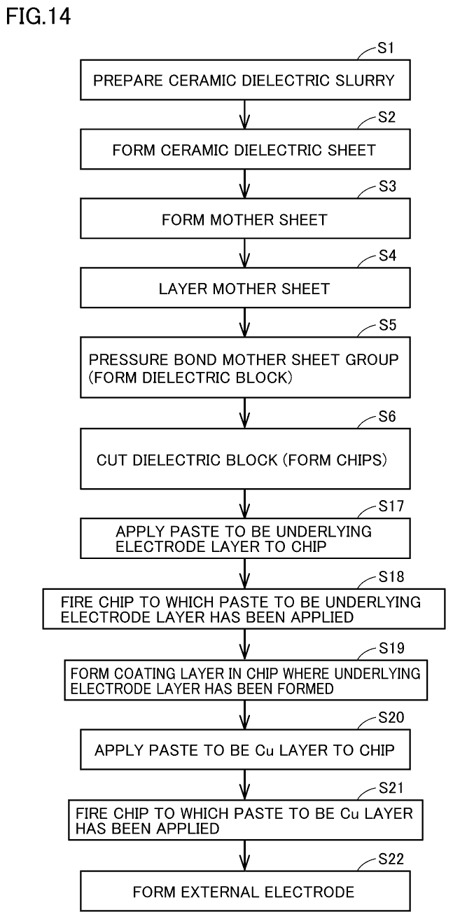

A method of manufacturing the multilayer ceramic capacitor according to the present modification will be described below. FIG. 14 is a flowchart showing the method of manufacturing the multilayer ceramic capacitor according to the modification.

As shown in FIG. 14, step S1 to step S6 in the method of manufacturing the multilayer ceramic capacitor according to the modification are similar to those in the method of manufacturing multilayer ceramic capacitor 100.

After step S6, a paste to be the underlying electrode layer is applied to the chip (step S17). Specifically, a paste containing Ni particles is applied to each of end surface 101e and end surface 101f of multilayer body 101 and dried.

The chip to which the paste to be underlying electrode layer 40 has been applied is then fired (step S18). Specifically, the chip is heated so that the paste containing Ni particles is fired together with the dielectric material and the conductive material contained in the chip and multilayer body 101 and underlying electrode layer 40 are formed.

Coating layer 160 is then formed in the chips provided with underlying electrode layer 40 (step S19). Specifically, multilayer body 101 provided with underlying electrode layer 40 is immersed in a solution containing Si and K and thereafter dried. The solution is, for example, water glass containing K.

A paste to be Cu layer 10 is then applied to the chips (step S20). Specifically, the paste containing the glass component while it contains Cu particles is applied to cover underlying electrode layer 40 on each of first end surface 115 and second end surface 116 with coating layer 160 being interposed and dried.

The chips to which the paste to be Cu layer 10 has been applied are then fired (step S21). Specifically, the chips to which the paste to be Cu layer 10 has been applied are fired at a temperature not lower than 600° C. and not higher than 800° C. A metallic component contained in the paste to be Cu layer 10 is thus sintered and coating layer 160 is molten, so that underlying electrode layer 40 and Cu layer 10 are electrically connected to each other.

The external electrode is then formed (step S22). Ni plating and Sn plating are applied to Cu layer 10 in this order to form Ni plated layer 20 and Sn plated layer 30, and thus first external electrode 120 and second external electrode 130 are formed. (Additional Aspects)

An illustrative embodiment described above is understood by a person skilled in the art as specific examples of aspects below.
1

A multilayer ceramic capacitor includes an element body portion including a plurality of dielectric layers and a plurality of internal electrode layers that are layered in a layering direction, the element body portion being provided with a first main surface and a second main surface opposed to each other in the layering direction, a first side surface and a second side surface opposed to each other in a width direction orthogonal to the layering direction, and a first end surface and a second end surface opposed to each other in a length direction orthogonal to the layering direction and the width direction, and an external electrode provided on each of the first end surface and the second end surface, the external electrode being electrically connected to the plurality of internal electrode layers, and in the element body portion, side margin portions located between the first side surface and the plurality of internal electrode layers and between the second side surface and the plurality of internal electrode layers in the width direction are formed from a coating layer containing Si and K.

2

In the multilayer ceramic capacitor described in <1>, the element body portion includes a first outer layer portion located closer to the first main surface relative to an internal electrode layer among the plurality of internal electrode layers which is located closest to the first main surface in the layering direction and a second outer layer portion located closer to the second main surface relative to an internal electrode layer among the plurality of internal electrode layers which is located closest to the second main surface in the layering direction, and each of the first outer layer portion and the second outer layer portion is formed from at least one of the plurality of dielectric layers and the coating layer.

3

In the multilayer ceramic capacitor described in <1> or <2>, the coating layer is located between the plurality of dielectric layers and the external electrode. <4

In the multilayer ceramic capacitor described in any one of <1> to <3>, a shortest distance between the plurality of internal electrode layers and the first side surface and a shortest distance between the plurality of internal electrode layers and the second side surface are not shorter than 0.01 μm and not longer than 0.5 μm.

5

In the multilayer ceramic capacitor described in <2>, a minimum thickness of the coating layer in the layering direction in each of the first outer layer portion and the second outer layer portion is not smaller than 0.01 μm and not larger than 0.5 μm.

6

In the multilayer ceramic capacitor described in any one of <1> to <5>, the coating layer is amorphous.

Through a series of steps described above, the multilayer ceramic capacitor according to the modification can be manufactured. According to the present disclosure, a multilayer ceramic capacitor, as described above, can be reduced in size and increased in capacitance while lowering in moisture resistance is suppressed.

In the description of the embodiment above, features that can be combined may be combined.

It should be understood that the embodiment disclosed herein is illustrative and non-restrictive in every respect. The scope of the present invention is defined by the terms of the claims rather than the description above and is intended to include any modifications within the scope and meaning equivalent to the terms of the claims.

### REFERENCE SIGNS LIST

10 Cu layer; 11 Cu component; 12 glass component; 20 Ni plated layer; 30 Sn plated layer; 40 underlying electrode layer; 100 multilayer ceramic capacitor; 101 multilayer body; 101a, 101b main surface; 101c, 101d side surface; 101e, 101f end surface; 110 element body portion; 111 first main surface; 112 second main surface; 113 first side surface; 114 second side surface; 115 first end surface; 116 second end surface; 120 first external electrode; 120E, 130E extension portion; 130 second external electrode; 140 dielectric layer; 150 internal electrode layer; 151 first internal electrode layer; 151C first opposed portion; 151N, 152N narrow-width portion; 151X first drawn portion; 152 second internal electrode layer; 152C second opposed portion; 152X second drawn portion; 160 coating layer; C inner layer portion; E1 first end margin portion; E2 second end margin portion; M1 first side margin portion; M2 second side margin portion; X1 first outer layer portion; X2 second outer layer portion; Xa outermost layer portion; Xb inner-side outer layer portion.

1. A multilayer ceramic capacitor, comprising:
an element body portion including a plurality of dielectric layers and a plurality of internal electrode layers that are layered in a layering direction, the element body portion including a first main surface and a second main surface opposed to each other in the layering direction, a first side surface and a second side surface opposed to each other in a width direction orthogonal to the layering direction, and a first end surface and a second end surface opposed to each other in a length direction orthogonal to the layering direction and the width direction; and
an external electrode on each of the first end surface and the second end surface, the external electrode being electrically connected to the plurality of internal electrode layers,
wherein the element body portion further includes side margin portions between the first side surface and the plurality of internal electrode layers and between the second side surface and the plurality of internal electrode layers in the width direction, the side margin portions include a coating layer that includes Si and K.

2. The multilayer ceramic capacitor according to claim 1, wherein:
the element body portion further includes:
a first outer layer portion located closer to the first main surface relative to an internal electrode layer among the plurality of internal electrode layers which is located closest to the first main surface in the layering direction, and
a second outer layer portion located closer to the second main surface relative to an internal electrode layer among the plurality of internal electrode layers which is located closest to the second main surface in the layering direction, and
each of the first outer layer portion and the second outer layer portion includes at least one of the plurality of dielectric layers and the coating layer.

3. The multilayer ceramic capacitor according to claim 1, wherein the coating layer is located between the plurality of dielectric layers and the external electrode.

4. The multilayer ceramic capacitor according to claim 1, wherein a shortest distance between the plurality of internal electrode layers and the first side surface and a shortest distance between the plurality of internal electrode layers and the second side surface are not shorter than 0.01 μm and not longer than 0.5 μm.

5. The multilayer ceramic capacitor according to claim 2, wherein a minimum thickness of the coating layer in the layering direction in each of the first outer layer portion and the second outer layer portion is not smaller than 0.01 μm and not larger than 0.5 μm.

6. The multilayer ceramic capacitor according to claim 1, wherein the coating layer is amorphous.

7. The multilayer ceramic capacitor according to claim 1, wherein the side margin portions directly contact ends of the plurality of internal electrode layers in the width direction.

8. The multilayer ceramic capacitor according to claim 7, wherein the coating layer includes portions projecting from a linear portion of the coating layer and covering the ends of the plurality of internal electrode layers in the width direction.

9. The multilayer ceramic capacitor according to claim 1, wherein the coating layer extends continuously on all surfaces of the element body portion.

10. The multilayer ceramic capacitor according to claim 9, wherein the external electrode on the first end surface and the second end surface of the element body portion is electrically connected to ends of respective ones of the plurality of internal electrode layers through the coating layer in the length direction.

11. The multilayer ceramic capacitor according to claim 10, wherein the external electrode includes a Cu layer on the coating layer, the Cu layer including a Cu component and a glass component.

12. The multilayer ceramic capacitor according to claim 11, wherein the Cu layer contacts the ends of respective ones of the plurality of internal electrode layers through the coating layer in the length direction.

13. The multilayer ceramic capacitor according to claim 11, wherein portions of the coating layer are between the Cu layer and the plurality of dielectric layers in the length direction.

14. The multilayer ceramic capacitor according to claim 1, wherein a concentration of K in the coating layer at ends of the plurality of internal electrode layers in the width direction is higher than a concentration of K in the coating layer between the plurality of dielectric layers at ends of the plurality of internal electrode layers in the length direction.

15. A method of manufacturing a multilayer ceramic capacitor, the method comprising:
forming a multilayer body including a plurality of dielectric layers and a plurality of internal electrode layers that are layered in a layering direction;
immersing the multilayer body in a solution containing Si and K to form a coating layer on the multilayer body, such that an element body portion is formed, the element body portion including a first main surface and a second main surface opposed to each other in the layering direction, a first side surface and a second side surface opposed to each other in a width direction orthogonal to the layering direction, and a first end surface and a second end surface opposed to each other in a length direction orthogonal to the layering direction and the width direction;
forming an external electrode on the coating layer on each of the first end surface and the second end surface of the element body portion, such that the external electrode is electrically connected to the plurality of internal electrode layers through the coating layer in the length direction,
wherein the element body portion further includes side margin portions between the first side surface and the plurality of internal electrode layers and between the second side surface and the plurality of internal electrode layers in the width direction, the side margin portions include the coating layer.

16. The method according to claim 15, wherein forming the external electrode includes forming a Cu layer on the coating layer.

17. The method according to claim 16, wherein forming the Cu layer includes:
applying a paste to the coating layer at each of the first end surface and the second end surface of the element body portion, the paste including Cu particles and a glass component; and
firing the paste on the coating layer to form the Cu layer, such that the Cu layer is connected to the plurality of internal electrode layers.

18. The method according to claim 17, wherein the firing is performed at a temperature of 600° C. to 800 ° C.
